(19) United States
(12) Patent Application Publication
(10) Pub. No.: US 2015/0210584 A1
(43) Pub. Date: Jul. 30, 2015

(54) METHOD AND A DEVICE OF MANUFACTURING AN OBJECT OF GLASS WITH AT LEAST ONE THREE-DIMENSIONAL FIGURINE ENCLOSED THEREIN

(71) Applicant: Ceraglass patenten B.V., Netherlands (NL)

(72) Inventor: Johannes Maria Zandvliet, Wassenaar (NL)

(73) Assignee: Ceraglass Patenten B.V., Leiden (NL)

(21) Appl. No.: 14/400,761

(22) PCT Filed: May 15, 2013
(86) PCT No.: PCT/EP2013/059992

§ 371 Date: Nov. 12, 2014

(30) Foreign Application Priority Data
May 15, 2012 (EP) 12168036.7

(51) Int. Cl. C03B 19/02; B44C 5/00; C03B 19/10

(52) U.S. Cl. CPC C03B 19/02; C03B 19/10; B44C 5/005

(57) ABSTRACT

A method of manufacturing an object of glass with at least one three-dimensional figurine enclosed therein, comprises the steps of pouring soft glass into a mold cavity and inserting a heated figurine into the glass. The glass temperature is higher than 1000° C. when inserting the figurine.

### CROSS-REFERENCE TO RELATED APPLICATION

The present application is a 371 national stage filing of International patent application Serial No. PCT/EP2013/059992, filed May 15, 2013, and published as WO 2013/171243 A1.

### BACKGROUND

The discussion below is merely provided for general background information and is not intended to be used as an aid in determining the scope of the claimed subject matter. The disclosure relates to a method of manufacturing an object of glass with at least one three-dimensional figurine enclosed therein.

Such a method is known from WO 99/33754. In the prior art method spherical glass articles including figurines are manufactured by successive steps of filling a bottom mold with a droplet of glass, supplying a figurine and pouring another droplet on the figurine and the already present glass. The glass article is then stamped to a spherical shape.

### SUMMARY

This Summary and the Abstract herein are provided to introduce a selection of concepts in a simplified form that are further described below in the Detailed Description. This Summary and the Abstract are not intended to identify key features or essential features of the claimed subject matter, nor are they intended to be used as an aid in determining the scope of the claimed subject matter. The claimed subject matter is not limited to implementations that solve any or all disadvantages noted in the background.

An aspect of the invention provides a new method for manufacturing an object of glass with a three-dimensional figurine enclosed therein.

This is achieved with the method which comprises the steps of pouring soft glass into a mold cavity and inserting a heated figurine into the glass, wherein the glass temperature is higher than 1000° C. when inserting the figurine.

Due to the relatively high temperature of the glass in the mold cavity its viscosity is still relatively low. As a consequence, the molten glass yields around the figurine rather easily. Furthermore, inserting the figurine into the glass requires relatively little pressure, which provides the opportunity to insert the figurine into the glass at relatively high speed. This results in increased manufacturing speed. In order to prevent the figurine from degradation due to a too high temperature difference, such as cracking, the figurine is pre-heated before being inserted into the glass.

The glass can be poured into a static mold cavity after which the figurine is pressed into the glass. It is noted that after pressing the figurine into the glass an additional amount of glass may be poured into the mold cavity.

The glass in the mold cavity may be heated before inserting the figurine in order to limit or prevent cooling down of the glass after pouring it into the mold cavity. This can be achieved by supplying heat through a filling hole to the mold cavity, for example by means of a burner. Keeping the viscosity relatively facilitates pressing the figurine into the glass.

The figurine may be heated to a temperature below the actual glass temperature in the mold cavity. This requires less heating of the figurines than in prior art manufacturing methods. The temperature to which the figurine is heated may depend on its size and shape.

The glass temperature may be higher than 1100° C. or 1150° C., and preferably higher than 1250° C. when inserting the figurine. This creates a still lower viscosity causing improved yielding characteristics of the glass around the figurine. It is also conceivable that the glass temperature in a glass melting bunker from which the glass is poured into the mold cavity, is higher than 1100° C. or 1150° C., and preferably higher than 1250° C.

In a practical embodiment the glass temperature is in the range of 1000-1300° C. and the figurine temperature is below 1000° C. upon inserting the figurine into the glass. This is possible until the glass is still not fully cured.

In a specific embodiment the glass including the figurine is pressed substantially to a desired shape after the step of inserting the figurine into the glass.

The invention is also related to a method of manufacturing an object of glass with at least one three-dimensional figurine enclosed therein, comprising the steps of pouring soft glass into a mold cavity and inserting a heated figurine into the glass, wherein the viscosity of the glass is lower than 10⁴ Pa·s when inserting the figurine, and preferably lower than 10³ Pa·s. In a practical glass composition, the temperature at these viscosity levels is 1022 and 1183° C., respectively. For the same glass composition the viscosity of the glass is 10² Pa·s at 1425° C. and 10⁵ Pa·s at 907° C.

The three-dimensional figurine may be composed of metal salts and/or metal oxides and the composition as oxide is a) 20-60 wt. % of Si02, b) 2.5-30 wt. % of Al203, and c) 30-65 wt. % of an oxide of Mg, Ca, and/or Ba, and wherein the sum of a+b+c>95 wt. %, and if there is a difference with 100 wt. %, this difference stands for metal oxides of metals other than Si, Al, Mg, Ca, or Ba, wherein the weight percentage is determined with regard to the total of the oxides. Examples of such metals are iron (II), iron (III), potassium, sodium, lithium, zinc, copper, lead, antimony, zirconium, strontium, arsenic, manganese, titanium, phosphorus (that is also considered as a metal), and the like. In view of this it is remarked that all non-gaseous oxides can be part of the composition in small amounts. Preferably, none of these other metal oxides occur in an amount above 1 wt. %. The total content of these other metal oxides is always smaller than 5 wt. %.

Alternatively, the three-dimensional figurine may be composed of metal salts and/or metal oxides and the composition as oxide is a) 30-40 wt. % of Si02, b) 5-10 wt. % of Al203, and c) 50-60 wt. % of an oxide of Mg, Ca, and/or Ba, and wherein the sum of a+b+c>95 wt. %, and if there is a difference with 100 wt. %, this difference stands for metal oxides of metals other than Si, Al, Mg, Ca, or Ba, wherein the weight percentage is determined with regard to the total of the oxides.

Further alternative compositions are conceivable. For example, an embodiment of the three-dimensional figurine is composed of 57.499 wt. % of Si0₂, 1.710 wt. % of Fe₂O₃, 35.199 wt. % of Al₂0₃, 0.353 wt. % of MgO, 0.043 wt. % of CaO, 5.110 wt. % of K₂O, 0.033% of Rb₂O and 0.053 wt. % of SO₃.

The glass may be any sort of glass. Because of the price and the ease of handling it is preferred to use soda lime glass. Such glass comprises 70-78 wt. % of silicon oxide, 10-18 wt. % of sodium oxide, 4-12 wt. % of calcium oxide, 0.1-5 wt. % of potassium oxide, and small amounts of different oxides. A suitable glass is for instance the sodium lime glass with 76 wt. % of silicon oxide, 16 wt. % of sodium oxide, 6 wt. % of calcium oxide, and 2 wt. % of potassium oxide. A different suitable glass comprises 72.5 wt. % of silicon oxide, 13.6 wt. % of sodium oxide, 8.8 wt. % of calcium oxide, 0.6 wt. % of potassium oxide, 2 wt. % of aluminium oxide, 1.9 wt. % of magnesium oxide, 0.08 wt. % of iron (III) oxide, 0.6 wt. % of antimony (III) oxide, and 0.01 wt. % of titanium oxide. Nevertheless glass having different compositions is conceivable, for example glass comprising 72-77 wt. % of silicon oxide, 11-13 wt. % of sodium oxide, 3-5 wt. % of calcium oxide, 2-3 wt. % of potassium oxide, 2-4 wt % B2O3, 0.5-2 wt % Al2O3, 1-3 wt % BaO, and small amounts of different oxides.

The glass may be a so-called hard glass. For example, a typical hard glass is borosilicate glass with low thermal expansion coefficient, in the order of 3.3×10⁻⁶K⁻¹. This glass is hard for melting, it is the Pyrex type. The composition is well known and the typical contents of SiO2 is about 80%. Generally the hardness of the glass depends on the amount of SiO2 in the glass. Preferably, the content of SiO2 in the glass is higher than 50% and more preferably higher than 70%.

The invention is also related to a device for manufacturing an object of glass with a three-dimensional figurine enclosed therein, comprising a mold assembly provided with a mold cavity whose shape corresponds at least substantially to the shape of the intended object and a feeder including a glass discharge for supplying molten glass to the mold assembly, wherein said mold assembly is provided with a filling opening for filling the mold cavity with molten glass and an insertion opening for inserting the figurine into the mold cavity, wherein the glass discharge is located directly above the filling opening.

The device according to the invention prevents the glass from severe cooling between the glass discharge and the mold assembly.

The distance between the glass discharge and the mold assembly may be less than 0.5 m, and preferably less than 0.25 m. In a prior art method the glass that leaves the glass discharge has a temperature of about 1100° C., but has to travel about 3 m through a chute before arriving at a mold. Therefore, the glass will be cooled down below 1000° C. upon entry of the mold.

The device may be arranged such that the temperature of the glass in the mold cavity after filling is higher than 1000° C. This can be achieved, for example, by a short distance between the glass discharge and the mold assembly as mentioned above, and/or by heating the molten glass to a relatively high temperature at the feeder. An elevated glass temperature results in decreased viscosity such that the glass flow between the glass discharge and the mold assembly is relatively narrow. Consequently, the filling opening may be narrow, as well. Alternatively, the device is provided with a heat source, for example a burner, for heating the glass in the mold cavity before inserting the figurine.

The figurine may have any shape, for example a disk shape, and may also carry a message for advertising, for example.

### BRIEF DESCRIPTION OF THE DRAWINGS

Aspects of the invention will hereafter be elucidated with reference to drawings showing embodiments of the invention very schematically.

FIG. 1 is a cut-away perspective view of a continuously operating glass furnace.

FIG. 2 is a cross-sectional view of a mold assembly which is used for making an object by means of an embodiment of the method.

FIGS. 3-6 are similar views as FIG. 2, but showing different conditions in the manufacturing process.

FIG. 7 is a cross-sectional view of a product that is manufactured by means of the mold assembly as shown in FIGS. 2-6.

### DETAILED DESCRIPTION OF THE ILLUSTRATIVE EMBODIMENTS

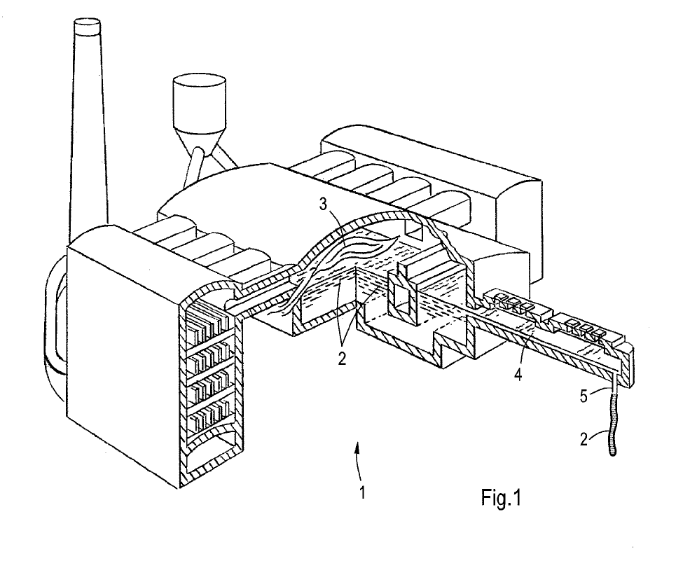

FIG. 1 shows a continuously operating glass furnace 1, which contains a mass of molten glass 2. The glass 2 is heated by means of flames 3. Under operating conditions the molten glass 2 flows through a feeder 4 to a glass discharge 5. The glass 2 may be heated to a temperature of 1100-1700° C., in practice about 1300° C. This means that the glass temperature upon leaving the glass discharge 5 may have a temperature of about 1300° C. At this temperature the viscosity of the molten glass is rather low such that a flow of molten glass 2 below the glass discharge 5 is relatively narrow.

The flow of glass 2 that leaves the glass discharge 5 is received by a mold assembly 6 which is located just below the glass discharge 5. The distance between the glass discharge 5 and the mold assembly 6 is preferably smaller than 0.25 m in order to minimize cooling of the glass 2 before it arrives at the mold assembly 6. When an amount of glass 2 is poured into the mold cavity 9 the glass flow at the glass discharge 5 is stopped shortly and a next mold assembly 6 is positioned below the glass discharge 5 such that the glass flow may be started again.

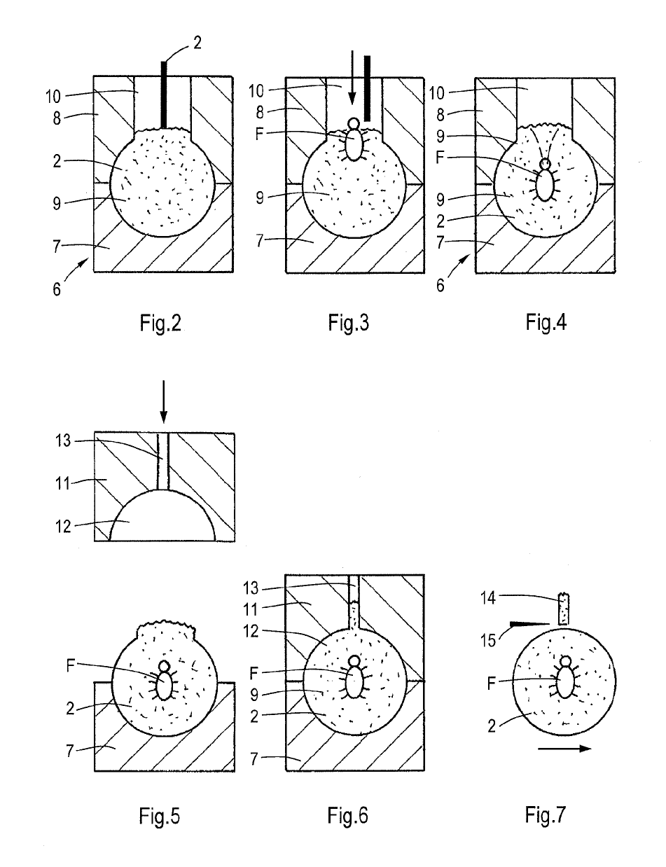

FIG. 2 shows an embodiment of a mold assembly 6 for making an object of glass in the form of a marble with a three-dimensional figurine enclosed therein. The mold assembly 6 includes a lower mold 7 and an upper mold 8, which together form a mold cavity 9. The upper mold 8 is provided with a filling hole 10 for filling the mold cavity 9 with soft glass 2. FIG. 2 illustrates a condition in which the mold cavity 9 is filled with soft glass 2. In this condition the glass temperature is still above 1000° C. It appears that an optimal result is obtained when the glass temperature in the mold is 1000° C. or higher and the temperature of the figurine is about 700° C. In an alternative embodiment the glass in the mold cavity 9 as shown in FIG. 2 is heated before the figurine F is pressed into the glass, as shown in FIG. 3 in order to prevent the glass from severe cooling after being poured into the mold cavity. This can be done by a burner (not shown) which is directed into the filling hole 10.

In a next step, possibly after filling of the mold cavity 9 with glass 2 has stopped, a figurine F is inserted into the soft glass 2 via the same filling hole 10. FIG. 3 illustrates how the figurine F is inserted into the glass 2. This may be performed at relatively high speed. Since in this case the viscosity of the glass 2 is still relatively low a relatively low pressure is required for inserting the figuring F into the glass 2. The figurine F may have any three-dimensional shape and is made of a material which preferably has a coefficient of expansion in the range of that of the glass 2, often a ceramic material. Depending on the size of the figurine F in relation to the size of the mold cavity 9 the filling hole 10 may be wider or narrower than shown in FIG. 3.

Before the figurine F is inserted into the glass 2 it is pre-heated in order to avoid a large temperature difference between the glass 2 and the figurine F which may cause degradation of the figurine F, for example cracking. Contrary to known prior art manufacturing processes the figurine F is pre-heated to a temperature which is below the actual glass temperature upon inserting it into the glass 2. Due to the relatively high glass temperature, above 1000° C. or 1100° C. and preferably above 1200° C., in the mold cavity 9 the viscosity of the glass 2 is still low and the glass appears to yield around the figurine F accurately. Furthermore, formation of air inclusions appears to be minimized. In practice, a ceramic figurine F is pre-heated to a temperature above 500° C. and below 1000° C.

FIG. 4 illustrates that due to the presence of the figurine F in the mold cavity 9 the glass level in the upper mold 8 has increased with respect to the condition as shown in FIG. 3. It is noted that in the embodiment as illustrated in

FIGS. 2-4 the glass 2 and the figurine F are supplied to the mold cavity 9 via the same filling hole 10. In an alternative embodiment separate openings for supplying the glass 2 and the figurine F, respectively, to the mold cavity 9 are conceivable.

In the condition as illustrated in FIG. 5 the upper mold 8 has been removed and a new upper mold 11 has been supplied. The new upper mold 11 includes a hemispherical mold cavity 12 and an escape hole 13 having a smaller diameter than the filling hole 10 of the upper mold 8. The diameter of the escape hole 13 is selected in dependence on the volume of the figurine F that is to be inserted into the glass 2; the larger the volume of the figurine F, the larger the diameter of escape hole 13.

When the new upper mold 11 is pressed onto the lower mold 7, as is shown in FIG. 6, the resulting glass marble 2, which is too large, is compressed. The glass 2 is pressed fully against figurine F. The air that may be present is forced out. The glass above figurine F is closed and the excess glass is discharged, likewise at the upper side, via narrow escape hole 13. Since the hole is narrow, the pressure within the mold cavity 9 can nevertheless run up high. Subsequently, the new upper mold 11 is opened again and a pillar of abundant glass 14 from the escape hole 13 is cut off by cutting means 15, see FIG. 7.

It is noted that the discharge 5 at the feeder 4 may be controlled accurately, such that an amount of glass 2 is poured into the mold assembly 6, which amount of glass 2 substantially equals the amount of glass necessary for the final object. With reference to FIG. 7, the amount of glass 2 is controlled such that the pillar of abundant glass 14 does not arise in this case. The amount of glass is controlled in dependence of the volume of the figurine F. In case of such an accurate discharge control, it is even conceivable to eliminate the escape hole 13, as shown in FIGS. 5 and 6. It is also noted that in case of using an accurate control of glass supply from the discharge 5 it is not necessary to apply a new upper mold 11. On the contrary, the mold assembly may have opposite side parts including vertical contact surfaces, which form a common filling hole in assembled condition, instead of an upper mold 8 and a lower mold 7 as shown in FIG. 2.

Due to accurate control of glass supply, the resulting marble can be compressed in the mold cavity by inserting a press tool without an escape hole for releasing excess glass, for example a mandrel, through the filling hole after the steps of filling the mold cavity with glass and pressing the figurine into the glass. A contact surface of the press tool that contacts the glass may be concave such that the resulting product becomes spherical.

The glass marble 2 is placed on a roller (not shown), which has a length of about 1 to 15 m. At the end of the roller, the marbles move into an annealing furnace. In this furnace, the marbles are annealed for a long period in order to fully eliminate any stresses in the glass 2 surrounding figurine F. After leaving the annealing furnace the glass marbles 2 may be placed, as an optional step, on the roller again and be rolled into a perfectly round shape. Preferably, the marbles are partially reheated before being placed again on the roller.

Alternatively, it is conceivable to grind and polish the hardened and cooled marbles by tumbling them in a tumbler to obtain a perfectly round and polished marble. Such tumblers are known per se for shaping and finishing gemstones and the like. In this embodiment a roller is not used.

A further alternative for finishing the marbles is to process them in a bead fine grinding machine and/or a bead calibrating machine (for example model KF and/or model KKM from LUX+CO. KG). Polishing may be done by the above mentioned tumbling process again or by “flame polishing” on a roller.

From the foregoing it will be apparent that the invention provides a method and a device by means of which an object of glass with a figurine enclosed therein can be manufactured. The method can be carried manually or automatically to a smaller or larger extent, but in principle it is also possible to carry out the entire method by hand.

The invention is not restricted to the above-described embodiment as shown in the drawings, which can be varied in several ways without departing from the scope of the invention. Thus it is possible to use an adjustable mold or the like and a vacuum system instead of various upper molds. Furthermore, it is possible to insert several figurines, simultaneously or in succession, into the glass of the object at the same location or at different locations. Pressing a heated figurine into the glass and pressing the amount of glass with the figurine present therein substantially to a desired shape may also be done substantially simultaneously, or in a succession without changing the upper mold part but by movable mold parts.

1. A method of manufacturing an object of glass with at least one three-dimensional figurine enclosed therein, comprising pouring soft glass into a mold cavity and inserting a heated figurine into the glass, wherein the glass temperature is higher than 1000° C. when inserting the figurine.

2. The method according to claim 1, wherein the glass temperature is higher than 1150° C. when inserting the figurine.

3. The method according to claim 1, wherein the figurine is heated before being inserted into the glass to a temperature below the actual glass temperature in the mold cavity.

4. The method according to claim 1, wherein upon inserting the figurine into the glass, the glass temperature is in the range of 1000-1300° C. and the figurine temperature is below 1000° C.

5. The method according to claim 1, wherein the mold cavity is formed by a mold assembly comprising a lower mold and an upper mold, wherein the upper mold is provided with a filling hole through which the glass is poured into the mold cavity.

6. The method according to claim 5, wherein the figurine is inserted into the glass through the filling hole.

7. The method according to claim 1, wherein after inserting the figurine into the glass, pressing the glass including the figurine substantially to a desired shape.

8. A method of manufacturing an object of glass with at least one three-dimensional figurine enclosed therein, comprising pouring soft glass into a mold cavity and inserting a heated figurine into the the glass, wherein the viscosity of the glass is lower than 10⁴ Pa·s when inserting the figurine.

9. The method according to claim 1, wherein the three-dimensional figurine is composed of metal salts and/or metal oxides and the composition as oxide is:
a) 20-60 wt. % of Si02,
b) 2.5-30 wt. % of Al203, and
c) 30-65 wt. % of an oxide of Mg, Ca, and/or Ba, wherein the sum of a+b+c>95 wt. %, and if there is a difference with 100 wt. %, this difference stands for metal oxides of metals other than Si, Al, Mg, Ca, or Ba, wherein the weight percentage is determined with regard to the total of the oxides.

10. The method according to claim 1, and heating the mold cavity before inserting the figurine.

11. A device for manufacturing an object of glass with a three-dimensional figurine enclosed therein, comprising a mold assembly provided with a mold cavity whose shape corresponds at least substantially to the shape of the intended object and a feeder including a glass discharge configured to supply molten glass to the mold assembly, wherein said mold assembly is provided with a filling opening configured to fill the mold cavity with molten glass and an insertion opening configured to insert the figurine into the mold cavity, wherein the glass discharge is located directly above the filling opening.

12. The device according to claim 11, wherein the distance between the glass discharge and the mold assembly is less than 0.5 m.

13. The device according to claim 12, wherein the filling opening and the insertion opening comprise a common opening.

14. The device according to claim 11, wherein the device is arranged such that the temperature of the glass after filling the mold cavity is higher than 1000° C.

15. The device according to claim 11, wherein the mold cavity is formed by a mold assembly comprising a lower mold and an upper mold, wherein the upper mold is provided with the filling hole.

16. The device according to claim 11, wherein the mold cavity is formed by a static mold assembly which comprises at least two parts which form the mold cavity including a filling hole in assembled condition.

17. The method of claim 8 wherein the viscosity of the glass is lower than 10³Pa·s when inserting the figurine.

18. The method according to claim 1, wherein the mold assembly comprises at least two parts which form the mold cavity including a filling hole in assembled condition.

19. The method according to claim 1, wherein the glass temperature is higher than 1250° C. when inserting the figurine.
